(19) United States
(12) Patent Application Publication
(10) Pub. No.: US 2004/0194724 A1
(43) Pub. Date: Oct. 7, 2004

(54) Shelter

(76) Inventor: Gregory Mark Wood, Maroochydore (AU)

Correspondence Address: Laura G. Barrow, Esq., HAHN LOESER + PARKS, LLP, P.O. Box 215, Estero, FL, 33928-0215, US

(21) Appl. No.: 10/653,700

(22) Filed: Sep. 2, 2003

(30) Foreign Application Priority Data
Mar. 14, 2003 (AU) 2003201003

(51) Int. Cl. A01K 1/02

(52) U.S. Cl. 119/474

(57) ABSTRACT

A shelter is disclosed for an animal, the shelter consisting of a demountable first frame adapted to be releasably connectable to a first flexible cover, the first cover and the first frame being further adapted to support the animal when the shelter is in use; a demountable second frame releasably connectable to the first frame; a flexible second cover releasably connectable to and supported by the second frame, the second cover in combination with the first cover providing a substantially enclosed space for receiving the animal when the shelter is in use; wherein each of the first frame, the second frame, the first cover and the second cover are manufactured from a lightweight material and are adapted such that, when the shelter components are disassembled, they can be flat-packed.

### FOREIGN PRIORITY CLAIM

Under 35 U.S.C. § 119, this application is based upon, and claims the benefit of, prior Australian Patent Application No. 2003201003, filed Mar. 14, 2003, the entire contents of which is incorporated herein by reference.

### BACKGROUND AND SUMMARY OF THE INVENTION

This invention relates to a shelter. In particular, this invention is directed to a portable shelter that finds especial, but not limiting, use as a shelter for an animal, for example, a domestic pet such as a dog or cat.

A favourite domesticated animal is the dog. Despite its domesticity, a dog requires a cave-like quarters to rest which offer security and a comfortable sleeping accommodation elevated from the ground. Typically, such quarters are provided by the commonly known kennel.

However, a dog kennel, typically manufactured from metal or hardwood timber, is usually of a fixed construction and is generally bulky and cumbersome to transport. Such bulky fixed constructions are inconvenient when the kennel has to be moved, for example, for cleaning purposes or a change in residence.

It would thus be advantageous to provide a lightweight easily transportable shelter for an animal.

There are a number of prior art shelters which attempt to overcome the above identified disadvantages. However, such devices only address one of the problems. For example, the shelter may be transportable, but it is still relatively heavy; another may be lightweight but it is still relatively bulky; yet others include additional features which are not necessarily required by the purchaser, such as removable litter trays and close-fitting padding to cover the animal for extra warmth, these additional features adding to the weight and cost of the shelter.

There thus remains a need for a relatively inexpensive basic lightweight easily transportable animal shelter which, in general, is the object of the present invention.

According to the present invention, there is provided a shelter consisting of the components:

a first frame consisting of a pair of first end frame members and a pair of first side frame members;

a flexible support adapted to be releasably connectable to said first frame;

a second frame consisting of a pair of second end frame members and adapted to be releasably connectable to said first frame; and

a flexible cover releasably connectable to and supported by said second frame and adapted such that, in combination with said flexible support, provides a substantially enclosed space for receiving and supporting said animal when said shelter is in use;

wherein said pair of first end frame members are each connectable to a corresponding end of said flexible support and said pair of first side frame members are each connectable to a corresponding side of said flexible support, each end of said first end frame member and said first side frame member including a connector adapted to function as a disengagable snap-fit connection to a respective said second end frame member; and

wherein each of said first frame, said second frame, said flexible support and said flexible cover are manufactured from a lightweight material and are adapted such that, when said components are disassembled, said components can be packed together in a substantially flat configuration.

Preferably, said pair of second end frame members adapted such that, when said adjacent ends of said first end frame member and said first side frame member are connected to said second frame, said second end frame members extend above said first frame to a respective apex.

Optionally, a support member can extend between and be releasably connectable to each said apex.

Preferably, each end and each side of said flexible support include a sleeve through which a respective first end frame member or first side member may pass.

Preferably, said flexible cover has lower edges which are adapted to extend around respective said first end and said first side members of said first frame sufficient to be releasably secured to the undersurface of said flexible support.

Preferably, said lower edges of said flexible cover are secured to said undersurface of said flexible support by a hook and pile fastener commonly known as a VELCRO fastener.

Preferably, said flexible support is manufactured from a mesh material.

Preferably, said mesh material is a plastics material.

Preferably, said plastics material is polypropylene.

Preferably, said flexible cover is manufactured from a waterproof material.

Preferably, said waterproof material is selected from canvas, canvas-like or synthetic material.

Preferably, said first frame and said second frame are each manufactured from a hollow tubular material.

Preferably, said hollow tubular material is manufactured from metal.

Preferably, said metal is aluminium.

Preferably, each end of said first end frame member, said first side member and said support member includes a connector, one end of said connector having a spigot-like projection which is retained within respective said end of said first end frame member, said first side member or said support member, the other end of said connector terminating in a substantially C-shaped resilient portion adapted to function as a releasable push-fit connection to a respective said second end frame member.

Optionally, said second end frame members include stops to limit downward movement of said first end frame members when said shelter is in use.

### BRIEF DESCRIPTION OF THE DRAWINGS

A preferred embodiment of the present invention will now be described with reference to the accompanying drawings wherein:

FIG. 1 illustrates the components of a shelter in accordance with the present invention when disassembled;

FIG. 2 illustrates the components of FIG. 1 partially assembled to form a shelter; and

FIG. 3 illustrates a fully assembled shelter using the components depicted in FIG. 1.

### DETAILED DESCRIPTION OF THE PREFERRED EMBODIMENTS

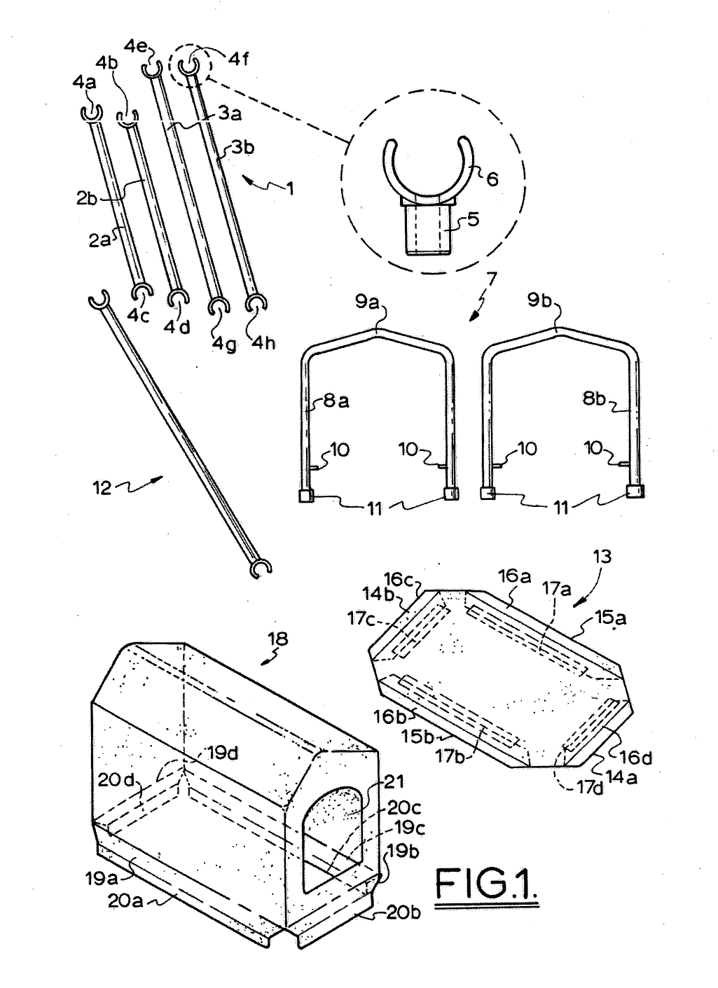

Referring to FIG. 1, the components of the shelter comprise a first frame (1), a second frame (7), a support member (12), a flexible support (13) and a flexible cover (18).

The first frame (1) includes two end members (2a,b) and two side members (3a,b). Each member (2a,b) (3a,b) is a hollow tube manufactured from aluminium. Each end of member (2a,b) (3a,b) incorporates a respective connector (4a-h), manufactured from polypropylene. As typified by connector (4h), each connector (4a-h) comprises a spigot-like protrusion (5) at one end and a substantially C-shaped arm (6) at the other end; the spigot (5) being secured within the respective hollow tube member (2a,b) (3a,b). The dimensions of each C-shaped arm (6) are adapted so that it is a releasable push fit around the relevant portion of the exterior surface of the second frame (7).

The second frame (7) comprises two substantially C-shaped end members (8a,b). The base portion of the C-shape members (8a,b) is deformed slightly to create a respective apex (9a,b). Stops (10) are provided near the lower extremities of the arms of the end members (8a,b). The lower ends of the end members (8a,b) terminate in removable feet (11). The support member (12) is identical in construction to the first side member (3b).

The flexible support (13) is a mat-like plastic mesh of the type commonly used as sun shade material. The mesh is substantially rectangular in shape but with small triangular portions removed from the four comers. Each end (14a,b) and each side (15a,b) of the mesh are extended and folded back on themselves to be secured on the undersurface of the mesh thus forming sleeves (16a-d) through which a respective end frame member (2a,b) or side member (3a,b) may pass (see FIG. 2). Side (17a,b) and end (17c,d) strips of one half of a VELCRO material, spaced a short distance from and substantially parallel to the respective end (14a,b) or side (15a,b) of the mesh, are attached to the undersurface of the mesh with the gripping surface exposed.

The flexible cover (18) is shaped to fit over the second frame (7) when the shelter is assembled (FIGS. 2 & 3). The lower edges of the cover (18) are extended to form flaps (19a-d) which terminate in one half of a VELCRO material (20a-d), the gripping surfaces facing inwards. This half of the VELCRO material is complementary to the strips(17a-d) on the undersurface of the mesh of the flexible support (13). The flaps (19a-d) are of a length sufficient to enable them to pass under the end (2a,b) and side (3a,b) members to be affixed to the strips (17a-d) when the shelter is assembled. The cover (18) includes an opening (21) of a size sufficient to function as an entrance for the animal that will use the shelter.

Turning now to FIG. 2, the frame of the shelter is assembled by passing the end members (2a,b) through the respective sleeves (16c,d) in the support (13) and affixing the respective connectors (4a-d) to the second frame members (8a,b). Similarly, the side members (3a,b) are passed through the respective sleeves (16a,b) in the support (13) and the respective connectors (4a-h) are affixed to the second frame members (8a,b). Once the connectors (4a-h) are affixed, sufficient tension is available to enable the mesh (13) to support the animal that uses the shelter. The support member (12) is affixed between the apices (9a,b). Should the weight of the animal cause the end (2a,b) and side (3a,b) members to slide down the second frame (8a,b), the stops (10) subsequently arrest that movement.

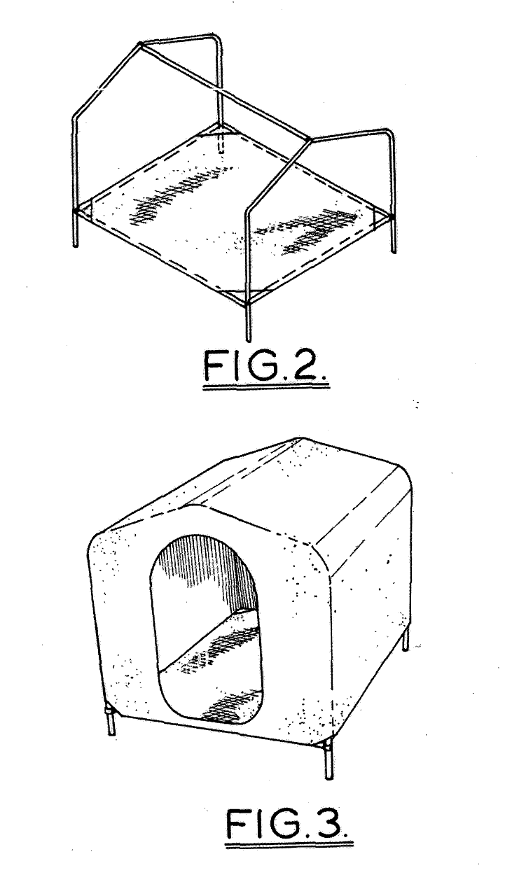

As illustrated in FIG. 3, once the frames (1,7) and flexible support (13) are in place, the flexible cover (18) can be slipped over the second frame (8a,b), the flaps being affixed to the VELCRO fastener on the undersurface of the mesh (13). This fastening arrangement ensures that there are no draughts between the mesh (13) and cover (18) of the shelter.

Disassembly of the shelter is simply the reverse of the procedure described above.

The present invention can thus provide a shelter for a domestic animal, particularly a dog, having a light frame and soft base, sides and top which is collapsible and easily transportable.

It will be appreciated that the above described embodiment is an exemplification of the invention only and that modifications and alterations can be made without departing from the inventive concept as defined in the following claims.

I claim:

1. A shelter for an animal, said shelter consisting of the components:
a first frame consisting of a pair of first end frame members and a pair of first side frame members;
a flexible support adapted to be releasably connectable to said first frame;
a second frame consisting of a pair of second end frame members and adapted to be releasably connectable to said first frame; and
a flexible cover releasably connectable to and supported by said second frame and adapted such that, in combination with said flexible support, provides a substantially enclosed space for receiving and supporting said animal when said shelter is in use;
wherein said pair of first end frame members are each connectable to a corresponding end of said flexible support and said pair of first side frame members are each connectable to a corresponding side of said flexible support, each end of said first end frame member and said first side frame member including a connector adapted to function as a disengagable snap-fit connection to a respective said second end frame member; and
wherein each of said first frame, said second frame, said flexible support and said flexible cover are manufactured from a lightweight material and are adapted such that, when said components are disassembled, said components can be packed together in a substantially flat configuration.

2. A shelter as defined in claim 1, wherein each of said second end frame members extend above said first frame to a respective apex.

3. A shelter as defined in claim 2, wherein a support member can extend between and be releasably connectable to each said apex.

4. A shelter as defined in claim 3, wherein each end of said support member includes a connector adapted to function as a disengagable snap-fit connection to a respective said second end frame member.

5. A shelter as defined in claim 1, wherein each end and each side of said flexible support includes a sleeve through which a respective first end frame member or first side member may pass.

6. A shelter as defined in claim 1, wherein said flexible cover has lower edges which are adapted to extend around respective said first end frame members and said first side frame members of said first frame sufficient to be releasably secured to the undersurface of said flexible support.

7. A shelter as defined in claim 6, wherein said lower edges of said flexible cover are secured to said undersurface of said flexible support by a hook and pile fastener.

8. A shelter as defined in claim 1, wherein said flexible support is manufactured from a mesh material.

9. A shelter as defined in claim 8, wherein said mesh material is a plastics material.

10. A shelter as defined in claim 9, wherein said plastics material is polypropylene.

11. A shelter as defined in claim 1, wherein said flexible cover is manufactured from a waterproof material.

12. A shelter as defined in claim 11, wherein said waterproof material is selected from canvas, canvas-like or synthetic material.

13. A shelter as defined in claim 1, wherein said first frame and said second frame are each manufactured from a hollow tubular material.

14. A shelter as defined in claim 13, wherein said hollow tubular material is manufactured from metal.

15. A shelter as defined in claim 14, wherein said metal is aluminium.

16. A shelter as defined in claim 1, wherein one end of said connector has a spigot-like projection which is retained within respective said end of said first end frame member or said first side frame member, and the other end of said connector terminates in a substantially C-shaped resilient portion adapted to function as said snap-fit connection.

17. A shelter as defined in claim 3, wherein said support member includes a connector at each end thereof, one end of each said connector having a spigot-like projection which is retained within respective said end of said support member, the other end of said connector terminating in a substantially C-shaped resilient portion adapted to function as a releasable snap-fit connection to a respective said second end frame member.

18. A shelter as defined in claim 1, wherein said second end frame members include stops to limit downward movement of said first frame members when said shelter is in use.
